(19) United States
(12) Patent Application Publication
(10) Pub. No.: US 2009/0169263 A1
(43) Pub. Date: Jul. 2, 2009

(54) CARRIER PARTICLES FOR DEVELOPER, DEVELOPER, AND IMAGE FORMING APPARATUS

(75) Inventors: Takeshi Watanabe, Kanagawa (JP); Mitsuaki Kouyama, Tokyo (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/341,887

(22) Filed: Dec. 22, 2008

Related U.S. Application Data
(60) Provisional application No. 61/016,735, filed on Dec. 26, 2007.

(51) Int. Cl. G03G 15/08; G03G 9/107; G03G 9/113

(52) U.S. Cl. 399/254; 430/111.3; 430/111.35

(57) ABSTRACT

Carrier particles for a developer used in an image forming apparatus, in which the carrier particles contain a core material containing magnetic particles, and a coating layer formed on a surface of the core material, and the coating layer contains diamond fine particles or diamond-like carbon exposed on a surface of the coating layer.

### CROSS-REFERENCE TO RELATED APPLICATION

This application is based upon and clams the benefit of priority from the prior U.S. Patent Application No. 61/016,735 filed on Dec. 26, 2007, the entire contents of which are incorporated herein by reference.

### TECHNICAL FIELD

The present invention relates to carrier particles for a developer used upon forming an image by an electrophotographic system, such as a duplicator and a printer, a developer and an image forming apparatus.

### BACKGROUND

An image forming apparatus using an electrophotographic system generally employs a magnetic brush developing system, in which a magnetic brush constituted by toner particles and magnetic carrier particles charging the toner particles is formed on a magnetic roller in a developing device, and an electrostatic latent image on a latent image holding member is developed by rubbing the latent image with the magnetic brush. As the magnetic carrier particles used in the magnetic brush developing system, a coated carrier is being developed, which contains a core material, such as iron powder, ferrite, magnetite or a binder resin having the magnetic material dispersed therein, having a coating layer that is provided in consideration of charging characteristics to the toner. Various types of coated carriers are subjected to practical use.

In particular, a resin-coated carrier having a resin coating layer provided on the surface thereof is widely used since it is enhanced in charge controlling characteristics and is improved in environmental dependency and time lapse stability. The resin coating layer is constituted, for example, by a polyester resin, a fluorine resin, an acrylic resin, a silicone resin and the like.

However, even though the resin-coated carrier is used, such problems occur that a toner cannot be given a sufficiently stable charge, the resin coating layer is peeled off in long-term use to deteriorate image quality due to charging failure. Furthermore, a spent phenomenon, in which the toner components, such as a releasing agent and a charge controlling agent, are attached to the carrier, occurs to deteriorate the function of the resin coating layer. Accordingly, the charging failure due to peel-off of the resin coating layer and the spent phenomenon bring about scattering of the toner and fogging on images in the developing part of the image forming apparatus.

As measures for preventing the coating from being peeled off, an approach from materials is made. For example, JP-A-2005-315907 discloses that a coating material is produced with a copolymer of an acrylate ester monomer.

As measures for suppressing the spent phenomenon from occurring, the coating layer is enhanced in releasing property. However, a coating material having high releasing property is generally inferior in adhesiveness to the core material and is liable to be peeled off. Accordingly, it is studied therefor that the coating material is modified with a silicone resin, or treated with a silane coupling agent to enhance both the releasing property and the adhesiveness.

For example, JP-A-2-33159 discloses that a compound of a silicone resin and a particular material is used as the coating material. However, it is poor in compatibility with the silicone resin to provide an uneven coating layer, thereby suffering such problems as difficulty in providing charging stability.

JP-A-2004-45773 discloses that fullerene or carbon nanotubes are incorporated in the coating layer to improve the charging stability and the durability. However, the technique has a problem of failing to provide sufficient releasing property.

In recent years, there is a requirement of decreasing the amount of waste materials, and accordingly, such an attempt is made that a used carrier is rinsed for reusing. However, when the coating layer is peeled off, it is necessary that the coating material is entirely peeled off, and the core material is rinsed and then again coated. When a material liable to suffer the spent phenomenon is used at the expense of releasing property for preventing the coating from being peeled off since it is costly to coat the core material again, it becomes necessary to rinse the carrier frequently. However, the coating layer of the carrier is damaged upon rinsing the carrier suffering the spent phenomenon, and thus the carrier cannot withstand repeated rinsing required for reusing.

As other issues on carrier particles than the aforementioned problem in durability of the carrier particle itself, it is required that the carrier particle applies less stress as small as possible to the surface of the photoconductor upon making into contact with the photoconductor, and even when the carrier particle is attached to the photoconductor and reaches other process steps than development, such as transferring or the like, the carrier particle does not damage the photoconductor, the belt and the like.

Owing to decrease in diameter of a toner associated with demand of high definition images, it becomes difficult to remove a fine powder toner and an additive of a toner with a photoconductor cleaner. Accordingly, a toner remaining on the non-image area of the photoconductor needs to be recovered to a developing device in the developing part. Furthermore, a cleanerless process using no photoconductor cleaner is widely used associated with reduction in size of an electrophotographic apparatus. The cleanerless process particularly requires a toner recovery performance on a non-developed part.

The recovery performance can be improved by making the tips of the magnetic brush constituted by toner particles and magnetic particles formed on the magnetic roller in the developing device to the photoconductor. However, when many of the tips of the carrier are made in contact with the photoconductor, the stress applied to the surface of the photoconductor is increased as described above. For reducing the stress on the surface of the photoconductor, it is necessary to improve the carrier particles in releasing property and lubricating property.

As described above, there is a requirement of improvement in releasing property and durability of a coated material of carrier particles.

### SUMMARY

The invention relates to, as one aspect, carrier particles for a developer, the carrier particles containing a core material containing magnetic particles, and a coating layer formed on a surface of the core material, the coating layer containing diamond fine particles or diamond-like carbon exposed on a surface of the coating layer.

The invention relates to, as another aspect, a developer containing carrier particles and toner particles, the carrier particles containing a core material containing magnetic particles, and a coating layer formed on a surface of the core material, the coating layer containing diamond fine particles or diamond-like carbon exposed on a surface of the coating layer.

The invention relates to, as still another aspect, an image forming apparatus forming an image with toner particles on a transfer medium, the apparatus containing an image holding member having an electrostatic latent image formed thereon, and a developing device that charges toner particles and carrier particles by agitation, and develops the electrostatic latent image on the image holding member by attaching the toner particles thereto, the carrier particles containing a core material containing magnetic particles, and a coating layer formed on a surface of the core material, the coating layer containing diamond fine particles or diamond-like carbon exposed on a surface of the coating layer.

It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute a part of this application, illustrate an embodiment of the invention and together with the description, serve to explain the principles of the invention.

FIG. 1 is a schematic diagram showing an image forming apparatus of a four-tandem process according to an embodiment of the invention;

FIG. 2 is a table showing constitutions of developers of examples and comparative examples, according to an embodiment of the invention;

FIG. 3 is a graph showing dependency of charging characteristics of a toner on an addition amount of a charge controlling agent, according to an embodiment of the invention;

FIG. 4 is a graph showing dependency of charging characteristics of a toner on an addition amount of a charge controlling agent, according to an embodiment of the invention;

FIG. 5 is a graph showing dependency of charging characteristics of a toner on an amount of diamond fine particles, according to an embodiment of the invention;

FIG. 6 is a schematic diagram showing an electrophotographic printer according to an embodiment of the invention;

FIG. 7 is a graph showing dependency of a fogging toner on a photoconductor (fogging amount) on a forced test time (number of sheets printed) according to an embodiment of the invention;

FIG. 8 is a graph showing dependency of a spent level on a forced test time (number of sheets printed) according to an embodiment of the invention;

FIG. 9 is a graph showing dependency of an abrasion amount of a photoconductor on a forced test time (number of sheets printed) according to an embodiment of the invention;

FIG. 10 is a graph showing dependency of an attached amount of carrier particles on a forced test time (number of sheets printed) according to an embodiment of the invention;

FIG. 11 is a graph showing dependency of a fogging amount associated with rinsing on a forced test time (number of sheets printed) according to an embodiment of the invention;

FIG. 12 is a graph showing dependency of an attached amount of carrier particles to a photoconductor associated with rinsing on a forced test time (number of sheets printed) according to an embodiment of the invention;

FIG. 13 is a schematic diagram showing an electrophotographic printer of a cleanerless process according to an embodiment of the invention;

FIG. 14 is a graph showing dependency of a density of a toner remaining after recovery on a gap between a developing roller and a photoconductor according to an embodiment of the invention; and

FIG. 15 is a graph showing dependency of a surface roughness of a photoconductor on a gap between a developing roller and a photoconductor according to an embodiment of the invention.

### DETAILED DESCRIPTION

Reference will now be made in detail to the present embodiment of the invention, an example of which is illustrated in the accompanying drawings.

The carrier particles for a developer of the embodiment contain a core material containing magnetic particles, and a coating layer formed on a surface of the core material, and the coating layer contains diamond fine particles or diamond-like carbon exposed on a surface of the coating layer.

Examples of the core material containing magnetic particles include magnetic particles, such as ferrite, magnetite and iron oxide, and resin particles containing the magnetic particles. Among these, ferrite particles are preferably used since the surface, the shape and the resistance of the core materials, which affect the characteristics of the carrier after forming the coating layer, can be easily controlled.

The core material preferably has a particle diameter of from 20 to 50 μm. When the diameter thereof is less than 20 μm, the carrier particles are liable to be released from a developer holding member and attached to a photoconductor due to the small magnetic force per one particle. When the diameter exceeds 50 μm, the magnetic brush becomes hard, thereby forming brush lines on an image and failing to feed the toner densely. The particle diameter of the core material is more preferably from 25 to 40 μm.

The coating layer formed on the surface of the core material is preferably formed on the entire surface of the core material. However, a part of the surface of the core material may not be coated, such as an area (point), at which the core material is supported for forming the coating layer, unless the functions of the coating layer including application of charge and releasing property are impaired.

The coating layer preferably has an average thickness of from 0.3 to 5 μm. When the thickness thereof is less than 0.5 μm, the stable charge controlling characteristics and the wear resistance cannot be obtained. When the thickness exceeds 3 μm, the charging property is decreased. The thickness of the coating layer is more preferably from 0.5 to 3 μm.

The diamond fine particles, which may be referred to as nanodiamond, used in the coating layer are such particles that are excellent in wear resistance and releasing property. The diamond fine particles are dispersed in a resin and coated on the surface of the core material in such a state that the diamond fine particles are partially exposed on the surface of the coating layer.

Examples of the resin include plastics and an elastomer including a thermoplastic elastomer and rubber. Preferred examples thereof include an acrylic resin, a fluorine resin, a silicone resin, a melamine resin, a urethane resin and a urethane elastomer.

The content of the diamond fine particles in the resin is preferably from 0.1 to 20% by weight. When the content thereof exceeds 20% by weight, sufficient charging characteristics may not be obtained. When the content is too small, the diamond fine particles cannot be exposed in a sufficient amount but are embedded, thereby failing to attain sufficient wear resistance and releasing property. The content of the diamond fine particles is more preferably from 1 to 10% by weight.

The coating layer containing diamond fine particles in a resin can be produced, for example, in such a manner that a dispersion liquid is prepared by mixing a solution containing the resin with the diamond fine particles in a ball mill or the like, and coating the dispersion liquid on the core material. The dispersion liquid may be coated by using a fluidized bed coating device under heating. The thickness of the coating layer can be controlled by changing the coating rate or repeating the coating operation. The coating layer may also be produced by a dipping method, a spraying method, a brush coating method, a kneading method and the like. In addition to the wet method using a solution, a dry coating method where resin powder is coated may be used.

The use of the coating layer containing diamond fine particles in a resin enhances the durability of the coating layer and also enhances the lubricating property of the carrier particles. The charging characteristics to toner particles can also be improved thereby.

The diamond-like carbon (hereinafter abbreviated as DLC), which is amorphous carbon, used in the coating layer is a material that is excellent in wear resistance and durability. The DLC film is formed on the surface of the core material by a film forming process, such as a CVD (chemical vapor deposition) method. The entire surface of the core material may not be coated. A single layer of the DLC film sufficiently functions as the coating layer, but a multilayer structure may be used. By using the multilayer structure, an area not coated with the coating layer, such as an area (point), at which the core material is supported for forming the coating layer, can be avoided, thereby substantially the entire surface of the core material can be coated.

The use of the coating layer containing the DLC film allows improving a low frictional property of the carrier particles. The DLC film has an inorganic structure without any solvent, and thus a spent toner can be easily rinsed upon recycling. Furthermore, the DLC film is formed by a CVD method or the like and thus adhered firmly to the surface of the core material, thereby enhancing the durability of the coating layer. Accordingly, the toner can be recycled semipermanently owing to the easiness of rinsing and the excellent durability. Consequently, the environmental load and the running cost can be reduced in the longer term although a high production cost is required upon forming the DLC film, and moreover, the charging characteristics can be improved.

It is generally appeared that the carrier particles having the coating layer containing diamond fine particles or DLC are high in electron donating property. In other words, the carrier particles have a high capability of charging the counterpart to a negative polarity upon frictional charging. A negatively charging toner is often used in an electrophotographic apparatus in recent years, and the carrier particles of the invention are suitable therefor.

The carrier particles are used with toner particles as a two-component developer for forming an image. The toner particles are constituted by a binder resin, a colorant, a releasing agent and the like.

Examples of the binder resin include a polyester resin, a styrene resin and a styrene-acrylic resin. Examples of the colorant include known pigments, such as carbon black, a condensed polycyclic pigment, an azo pigment, a phthalocyanine pigment and an inorganic pigment, and dyes. The toner particles may further contain a releasing agent, such as ester wax, a charge controlling agent for controlling frictional charge amount, such as a metal-containing azo compound, and inorganic fine particles such as silica, alumina and titanium oxide and organic fine particles for improving fluidity, charging property and storage stability. These components may have known composition and may be formed by a known method, such as a pulverizing method and a chemical production method.

The toner particles preferably have a volume average particle diameter of from 3 to 7 μm. When the volume average particle diameter thereof is less than 3 μm, the charge amount per weight may become too large upon applying a charge amount capable of controlling the electric field to the toner particles, thereby failing to provide an intended developed amount. When the volume average particle diameter exceeds 7 μm, a high-definition image may be deteriorated in reproducibility and granularity. The volume average particle diameter of the toner particles is more preferably from 4 to 6 μm.

An image may be produced with the developer in an image forming process, for example, a four-tandem electrophotographic system.

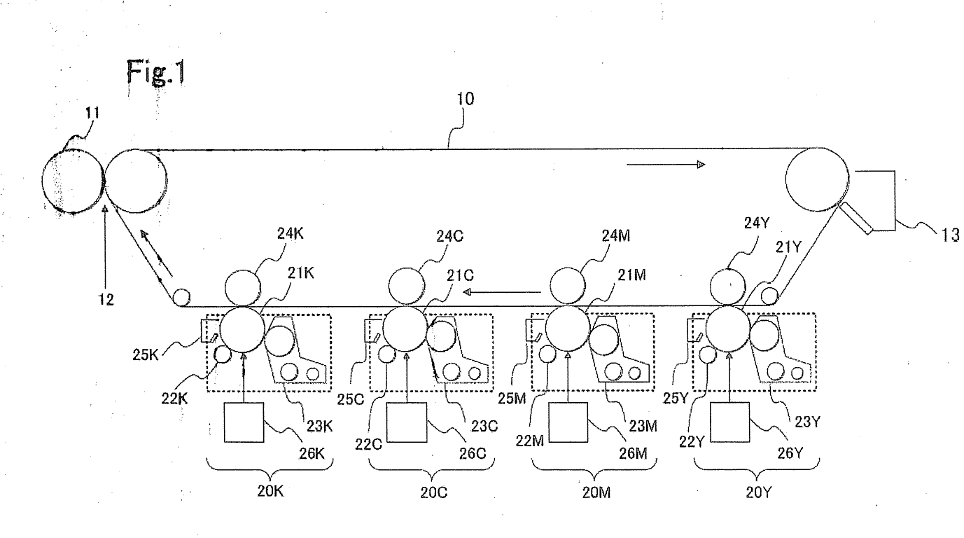

FIG. 1 is a schematic diagram showing an image forming apparatus of a four-tandem intermediate transfer process. As shown in FIG. 1, the image forming apparatus contains disposed therein image forming units 20Y, 20M, 20C and 20K each contain a developing device containing toner particles of yellow, magenta, cyan or black and carrier particles, a photoconductor as an image holding member (electrostatic latent image holding member), and charging, exposing and transferring devices. Each of the photoconductor 21Y, 21M, 21C or 21K are disposed in such a manner that the outer peripheral surface thereof is rotatable in the same direction at the position where the photoconductor is in contact with an intermediate transfer belt 10. Examples of the photoconductor include known photoconductors, such as an organic photoconductor (OPC) and an amorphous silicon photoconductor, which may be positively or negatively charged.

Images of respective colors formed on the photoconductors 21Y, 21M, 21C and 21K are transported in the direction shown by the arrow in FIG. 1 with the intermediate transfer belt 10. The intermediate transfer belt 10 runs in the direction shown by the arrow at a constant speed endlessly, and the image forming units 20Y, 20M, 20C and 20K are disposed in series along the transporting direction of the intermediate transfer belt 10.

The photoconductors 21Y, 21M, 21C and 21K each are connected to a drum motor (not shown), that rotates the photoconductor 21Y, 21M, 21C or 21K at a constant peripheral speed. The axis lines of the photoconductors 21Y, 21M, 21C and 21K each are disposed perpendicularly to the direction, in which the images are transported by the intermediate transfer belt 10. The photoconductors 21Y, 21M, 21C and 21K each are disposed to form constant intervals with the axis lines thereof.

A charging device 22Y, 22M, 22C or 22K as a charging unit, a developing device 23Y, 23M, 23C or 23K as a developing unit containing magnetic roller and a like, a primary transferring roller 24Y, 24M, 24C or 24K as a transferring unit, and a cleaner 25Y, 25M, 25C or 25K as a cleaning unit are disposed around each of the photoconductors 21Y, 21M, 21C and 21K along the rotation direction thereof.

The primary transferring rollers 24Y, 24M, 24C and 24K each are disposed at the position where the intermediate transfer belt 10 is held with the photoconductor 21Y, 21M, 21C or 21K, i.e., disposed inside the intermediate transfer belt 10.

Exposing devices 26Y, 26M, 26C and 26K that emit laser beams are disposed for forming electrostatic latent images formed through color separation on the outer peripheral surfaces of the photoconductors 21Y, 21M, 21C and 21K. The exposing devices 26Y, 26M, 26C and 26K each are disposed in such a manner that the exposure point is formed on the outer peripheral surface of the photoconductor 21Y, 21M, 21C or 21K between the charging device 22Y, 22M, 22C or 22K and the developing device 23Y, 23M, 23C or 23K.

A secondary transferring roller 11 is in contact with the intermediate transfer belt 10, and a transfer medium 12 is inserted between the intermediate transfer roller 10 and the secondary transferring roller 11, thereby the images are transferred from the intermediate transfer belt 10 to the transfer medium 12. In the embodiment shown in the figure, the image forming units are arranged in the order of yellow, magenta, cyan and black, but the order of colors is not limited thereto. A cleanerless process using no cleaner may be employed.

An image is formed by using the image forming apparatus in the following manner. The photoconductor 21Y is negatively (−) charged uniformly with the charging device 22Y. The photoconductor 21Y thus charged is exposed according to image information with the exposing device 26Y to form an electrostatic latent image. The electrostatic latent image on the photoconductor 21Y is reversely developed with the developing device 23Y to form a toner image on the photoconductor 21Y.

A bias of the reverse polarity (+) to the charging polarity of the toner is applied to the primary transferring roller 24Y with an electric power source (not shown). As a result, the toner image on the photoconductor 21Y is primarily transferred to the transfer belt 10 through a transferring electric field formed between the photoconductor 21Y and the primary transferring roller 24Y. The photoconductor 21Y after transferring is cleaned with the cleaner 25Y and then again subjected to the charging, exposing, developing process steps.

Synchronized with the image formation in the image forming unit 20Y, the similar process is performed in the image forming units, 20M, 20C and 20K. The toner images of magenta, cyan and black formed on the photoconductors of the image forming units 20M, 20C and 20K are also primarily transferred to the intermediate transfer belt 10 in series.

The transfer medium 12 is transported from a paper cassette (not shown) and fed to the intermediate transfer belt 10 with aligning rollers (not shown) synchronized with the toner images on the intermediate transfer belt 10.

A bias of the reverse polarity (+) to the charging polarity of the toner is applied to the secondary transferring roller 11 with an electric power source (not shown). As a result, the toner images are transferred to the transfer medium 12 through a transferring electric field formed between the intermediate transfer belt 10 and the secondary transferring roller 11. A fixing device (not shown) is disposed for fixing the toner transferred to the transfer medium 12, and the paper is subjected to the fixing device to form a fixed image.

The toner that is not completely transferred to the transfer medium 12 but partially remains on the transfer belt (toner remaining after transferring) is cleaned with a cleaner 13. In the cleanerless process, the toner remaining after transferring is recovered simultaneously with development.

The invention will be described specifically with reference to examples.

Carrier particles are formed in the following manner. Spherical ferrite (Mn—Mg—Sr ferrite) having a particle diameter of about from 35 to 45 μm (average particle diameter: about 40 μm) is used as a core material, and a coating layer is formed as follows.

### [Formation of Coating Layer Containing DLC]

The core material is placed in a plasma CVD apparatus, and a DLC film is formed on the surface of the core material under the following conditions.

Raw material gas: C₂H₄/H₂/NF₃ (flow rate ratio: 90/200/400 SCCM)

RF power: 100 W

Self-bias: 10 W

Reaction pressure: 2.5 Pa

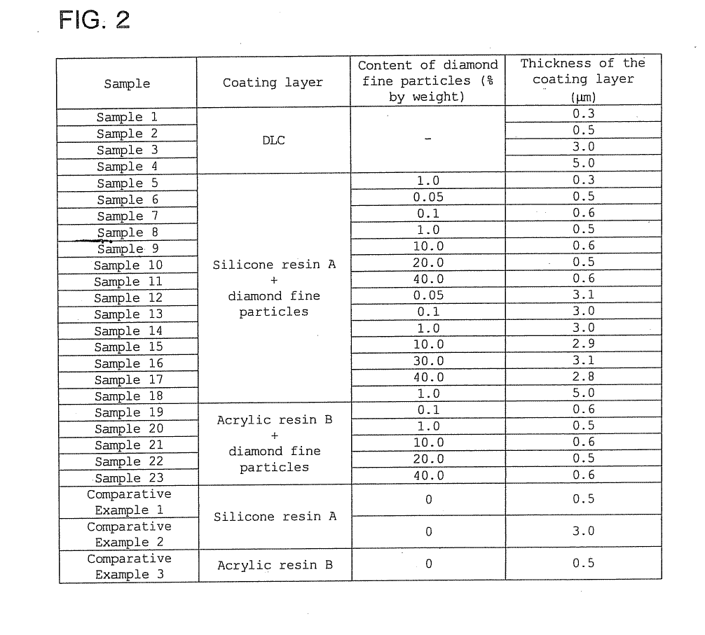

The thickness of the DLC film (thickness of the coating layer) is adjusted to 0.3 μm, 0.5 μm, 3 μm and 5 μm by controlling the film forming time to a period of from 20 to 100 minutes to provide samples 1 to 4 shown in FIG. 2.

The thickness of the coating layer is measured in such a manner that the carrier particle having the coating layer formed on the surface of the core material is embedded in a resin, followed by cutting, and the cut cross sectional surface is observed with a scanning electron microscope (SEM). Since it is difficult to form a coating layer having a uniform thickness, the thickness of the coating layer is measured at five sites randomly per one carrier particle, and the average value of the results obtained by measuring three particles is designated as the thickness of the coating layer. The same measurement is applied to the following examples.

### [Formation of Coating Layer Containing Diamond Fine Particles in Resin]

100 parts of a silicone resin (resin A) and 100 parts of an acrylic resin (resin B) are each diluted to provide a solution having a solid content of 5% by weight. Diamond fine particles (produced by New Metals & Chemicals Co., Ltd. or Sumiseki Materials Co., Ltd.) are added to the resin A and the resin B, respectively, in an amount of 0.05% by weight, and the mixtures are each dispersed in a ball mill to prepare dispersion liquids.

The dispersion liquids each are coated on the surface of the core material with a fluidized bed coating device at a coating speed of about 50 g/min at an atmospheric temperature of 100° C. The coated core material is further heated to 250° C. for 2 hours to form a coating layer having a thickness of 0.5 μm on the surface of the core material.

The concentration of the diamond fine particles is adjusted to a range of from 0.05 to 40% by weight, and the thickness of the coating layer is adjusted to a range of from 0.5 to 5.0 μm by controlling the coating speed of the dispersion liquid, or repeating the coating operation, so as to provide samples 5 to 23 shown in FIG. 2.

### [Formation of Coating Layer of Comparative Example]

A silicone resin (resin A) and an acrylic resin (resin B) are each used solely as a coating layer and coated on the surface of the core material, followed by heating, in the same manner as in the formation of the coating layer containing diamond fine particles. The thickness of the coating layer is adjusted to 0.5 μm and 3.0 μm by controlling the coating speed to provide comparative examples 1 to 3 shown in FIG. 2.

The carrier particles of the samples 1 to 23 and the comparative examples 1 to 3 are evaluated in the following manner.

### Evaluation of Dependency of Charging Characteristics of Toner on Addition Amount of Charge Controlling Agent

A pulverized toner containing a styrene-acrylic resin as a major component is used to prepare toner particles containing CrAC (chromium-containing azo dye) as a charge controlling agent of a negatively charging type in an amount of 0% by weight, 0.5% by weight and 1% by weight. 180 g of the carrier particles of the samples and the comparative examples and 20 g of the toner particles are placed in a plastic bottle, and mixed by shaking with hand for about 180 seconds. The samples thus mixed (developers) are each sampled and measured for charging amount per unit weight (q/m) with Espart Analyzer, produced by Hosokawa Micron Co., Ltd.

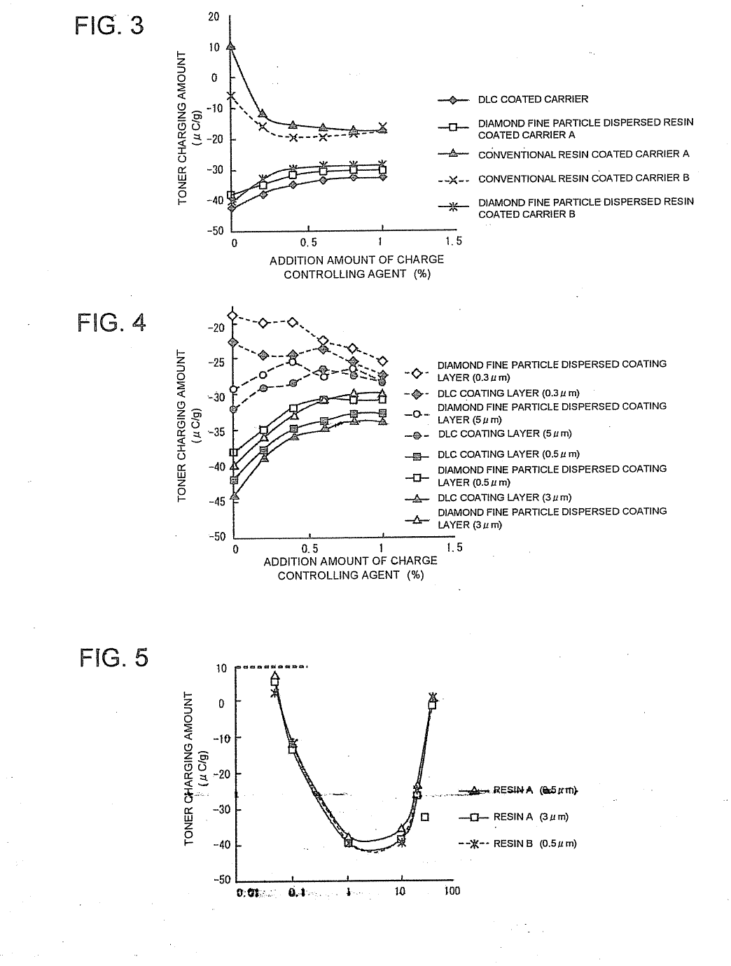

FIG. 3 shows the dependency of the charging characteristics of the toner on the addition amount of the charge controlling agent according to the measurement results of charge amount of the samples 2, 8 and 20 and the comparative examples 1 and 3. The carrier particles having a coating layer containing a DLC film or diamond fine particles can impart negative charging characteristics stably to the toner particles even though the charge controlling agent (CCA) is not added to the toner particles. In the carrier particles using diamond fine particles, there is no significant difference found between the samples 8 and 20, i.e., between the silicone resin (resin A) and the acrylic resin (resin B).

The carrier particles of the comparative examples are positively charged when no CCA is added, and is negatively charged by adding the CCA. Accordingly, by using the carrier particles of this embodiment, negative charge can be applied stably to toner particles without addition of a CCA. For example, even when a CCA is dropped off from the toner particles or embedded in the toner particles, stable charging characteristics can be obtained. Furthermore, toner particles containing no CCA can be used. It is considered this is because of the electron donating property of diamond.

FIG. 4 shows the dependency of the charging characteristics of the toner on the addition amount of the charge controlling agent according to the evaluation results of the samples 1 to 4, 5, 8, 14 and 18. The carrier particles having a coating layer containing a DLC film or diamond fine particles are compared for charging characteristics with respect to the thickness of the coating layer of 0.5 μm or 3.0 μm, and substantially no difference in charging characteristics is found. When the thickness is 0.3 μm or 5.0 μm, the charging characteristics are slightly lowered but are improved as compared to the comparative example 1.

### [Evaluation of Dependency of Charging Characteristics of Toner on Amount of Diamond Fine Particles]

The aforementioned pulverized toner containing a styrene-acrylic resin as a major component is used to prepare toner particles having no CCA added. 180 g of the carrier particles of the samples and the comparative examples and 20 g of the toner particles thus prepared are placed in a plastic bottle, and mixed by shaking with hand for about 180 seconds, as similar to the above. The samples thus mixed (developers) are each sampled and measured for charging amount per unit weight (q/m) with Espart Analyzer, produced by Hosokawa Micron Co., Ltd, as similar to the above. Accordingly, the charging characteristics of the toner particles with the carrier particles in a state where no CCA is added are thus evaluated.

FIG. 5 shows the dependency of the charging characteristics of the toner on the amount of the diamond fine particles according to the measurement results of the samples 5 to 23. The charge amount of the toner particles is 10 μC/g with no diamond fine particle added, and an addition amount of the diamond particles of 0.05% by weight exhibits substantially no effect. An addition amount of from 0.1 to 20% by weight exhibits the effect of addition as the charge amount of the toner particles becomes −10 μC/g or less. An addition amount of 40% by weight exhibits substantially no effect of addition as the absolute value of the charging amount becomes small.

For the silicone resin (resin A), there is substantially no significant difference between an average thickness of the coating layer of about 0.5 μm (samples 5 to 11) and about 3 μm (samples 12 to 17). The similar tendency as in the silicone resin is obtained in the acrylic resin (resin B). It is considered that the optimum range of the addition amount for charging characteristics does not depend on the thickness of the coating layer and the kind of the resin.

### [Evaluation of Fogging Amount on Forced Durability Test]

The aforementioned pulverized toner containing a styrene-acrylic resin as a major component is used to prepare toner particles containing CrAC (chromium-containing azo dye) in an amount of 0% by weight and 0.5% by weight. The carrier particles of the samples and the comparative examples and the toner particles thus prepared are placed in a two-component developing device of an electrophotographic printer using an organic photoconductor, and a continuous printing test of A4 size at a printing ratio of 6% is performed.

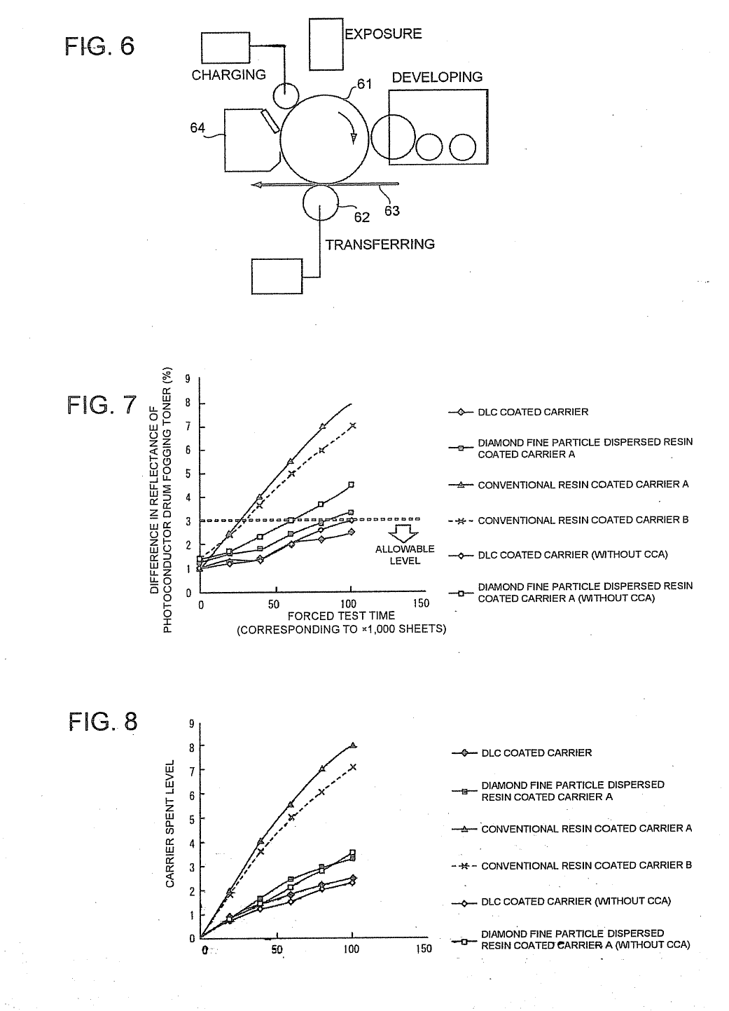

FIG. 6 is a schematic diagram of the electrophotographic printer. A photoconductor 61 is a negatively charging organic photoconductor having a multilayer structure. A voltage of from about +600 V to +1 kV is applied to the photoconductor 61 with a transferring roller 62 to transfer a toner image to paper 63 as a final transfer medium. The toner image is then fixed to the paper with a fixing device (not shown). The toner remaining on the photoconductor 61 is removed with a cleaner 64.

The continuous printing test is performed in this manner, and the fogging amount is measured every 20,000 sheets printed. The fogging toner at the white background potential is collected with a plastic adhesive tape (Mending Tape), which is then adhered to white paper and measured for reflectance with a color-difference meter, produced by Konica Minolta, Inc. The plastic adhesive tape itself is similarly adhered to white paper and measured for reflectance density. The difference in reflectance density is designated as a fogging amount.

The fogging amount on a photoconductor is preferably as small as possible. When a toner of a reverse polarity (positively charged) is attached, the toner basically does not appear on paper, to which an image is transferred, but the fogging toner is removed with a photoconductor cleaner, and the toner is wasted to increase the amount of the waste toner. In general, a fogging amount of 3% or less is considered to be favorable.

FIG. 7 shows the dependency of the fogging toner on the photoconductor (fogging amount) on the forced test time (number of sheets printed). The carrier particles having a coating layer containing a DLC film or diamond fine particles exhibit a suppressed fogging amount on the continuous test for a prolonged period of time, as compared to the conventional carrier particles having a coating layer containing only a resin.

The conventional carrier particles exhibit a fogging amount exceeding 3% at about 30,000 sheets printed, but the carrier particles using a DLC film maintains a value lower than 3% even after printing 100,000 sheets. It is considered that this is because the toner particles can be stably charged even when the CCA of the toner particles is embedded or dropped off due to the continuous printing.

The carrier particles having a coating layer containing a DLC film or diamond fine particles exhibit a suppressed fogging on a photoconductor even when no CCA is added. The fogging amount is slightly suppressed when a CCA is added. It is considered that this is because even when the coating layer containing a DLC film or diamond fine particles is deteriorated by attaching the toner component to the coating layer, the charging characteristics can be maintained in some degree by the CCA added.

### [Evaluation of Spent Level on Forced Durability Test]

The developer subjected to the same continuous printing test as in the evaluation of fogging amount is collected in several grams from the developing device, and the attached amount of the toner component is estimated from the carbon amount to evaluate the spent level.

FIG. 8 shows the dependency of the spent level on the forced test time (number of sheets printed). A larger value shows a larger amount of the toner component attached to the surface of the carrier particles. The carrier particles having a coating layer containing a DLC film or diamond fine particles exhibit a suppressed spent level as compared to the conventional carrier particles having a coating layer containing only a resin. Accordingly, it is understood that the toner component is difficult to be attached to the carrier particles to provide excellent releasing property. It is considered that the aforementioned advantages in the evaluation of fogging amount is obtained by the DLC film or the diamond fine particles owing to the high releasing property.

There is no significant difference in spent level depending on the presence of the CCA. The effect of the coating layer is deteriorated by progress of the spent phenomenon, and the addition of the CCA exhibits no effect on the spent level although the fogging amount is improved in some degree by the addition of the CCA.

### [Evaluation of Abrasion Amount of Photoconductor on Continuous Durability Test]

The photoconductor drum subjected to the same continuous printing test as in the evaluation of fogging amount is measured for the thickness of the photoconductor with an eddy-current thickness meter every 20,000 sheets printed to evaluate the abrasion amount of the photoconductor drum.

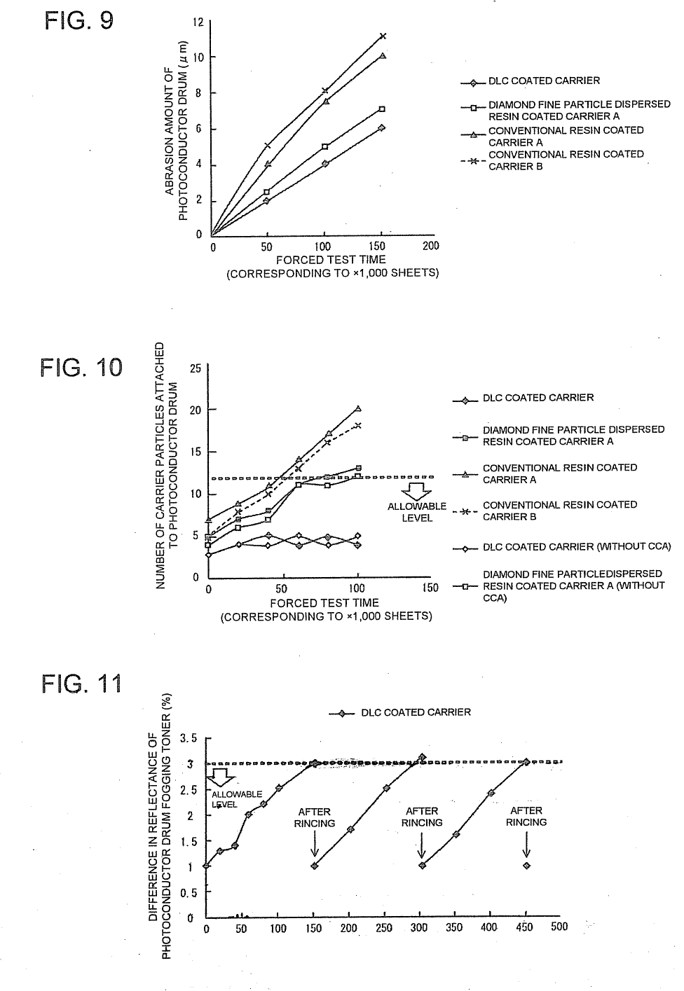

FIG. 9 shows the dependency of the abrasion amount of the photoconductor on the forced test time (number of sheets printed). The carrier particles having a coating layer containing a DLC film or diamond fine particles exhibit a suppressed abrasion amount of the photoconductor drum as compared to the conventional carrier particles having a coating layer containing only a resin. That is, the stress to the photoconductor is found to be suppressed.

### [Evaluation of Attached Amount of Carrier Particles on Photoconductor in Continuous Durability Test]

The photoconductor drum subjected to the same continuous printing test as in the evaluation of fogging amount is measured for the number of the carrier particles attached to an 80 cm² area of the photoconductor at the white background potential every 20,000 sheets printed to evaluate the attached amount of the carrier particles on the white background of the photoconductor.

The attachment of the carrier particles is liable to occur when the resistance of the carrier is decreased and thus can be considered as an index of peel-off of the coating layer of the carrier. When the carrier particles are attached in a larger amount, not only do they appear as image defects (white spots) on paper, but also the photoconductor is damaged to provide a severe problem. The number of the carrier particles attached to the photoconductor is preferably as small as possible, and it is sufficient that the number of the carrier particles is suppressed to 12 or less per an 80 cm² area of the photoconductor.

FIG. 10 shows the dependency of the attached amount of the carrier particles on the forced test time (number of sheets printed). Particularly in the carrier particles having a coating layer containing a DLC film, the attached amount of the carrier particles is not changed by repeating the printing operation and is maintained 5 or less until 100,000 sheets printed. Accordingly, it is considered that the coating layer has high adhesiveness to the core material, and thus the coating layer of the carrier particles is substantially not peeled off.

In the carrier particles having a coating layer containing diamond fine particles, the attached amount of the carrier particles is suppressed as compared to the conventional carrier particles having a coating layer containing only a resin. It is considered that this is because the adhesiveness of the coating layer to the core material is not improved since the same resin is commonly used, but the diamond fine particles dispersed enhance the releasing property and the lubricating property. Accordingly, the mechanical stress applied to the carrier particles is suppressed thereby to prevent the coating layer from being peeled off, thereby suppressing the carrier particles from being attached to the photoconductor. There is also no significant difference in attached amount of the carrier particles depending on the presence of the CCA.

As understood from the evaluation of the continuous durability test, the use of the carrier particles of the examples according to the invention stabilizes the charging characteristics of the toner to maintain high image quality for a prolonged period of time without a CCA added to the toner particles. Furthermore, a CCA may be added to the toner particles to stabilize further the charging characteristics of the toner, thereby considerably enhancing the degree of freedom in designing the toner.

### [Evaluation of Rinsing Effect of Carrier Particles Using DLC Film]

The carrier particles of the sample 2 having a coating layer containing a DLC film are measured for the fogging amount and the attached amount of the carrier particles to the photoconductor drum by the same continuous printing test. After printing 150,000 sheets, the toner particles and the carrier particles are separated from the developer with a sieve. The carrier particles thus separated are rinsed with a solvent, such as hexafluoroisopropanol or dichlorobenzene, followed by drying, and then again mixed with the separated toner particles to regenerate the developer. The regenerated developer is measured for the fogging amount and the attached amount of the carrier particles to the photoconductor drum by the same continuous printing test. The same operation is repeated until 450,000 sheets printed in total.

FIG. 11 shows the dependency of the fogging amount associated with rinsing on the forced test time (number of sheets printed). When the carrier particles are rinsed after performing the 150,000 sheets continuous printing test, the fogging amount is restored to the initial level. After performing further the 150,000 sheets continuous printing test, the fogging amount is increased as similar to the test result of the initial 150,000 sheets test. When the carrier particles are again rinsed in the similar manner, the fogging amount is again restored to the initial level.

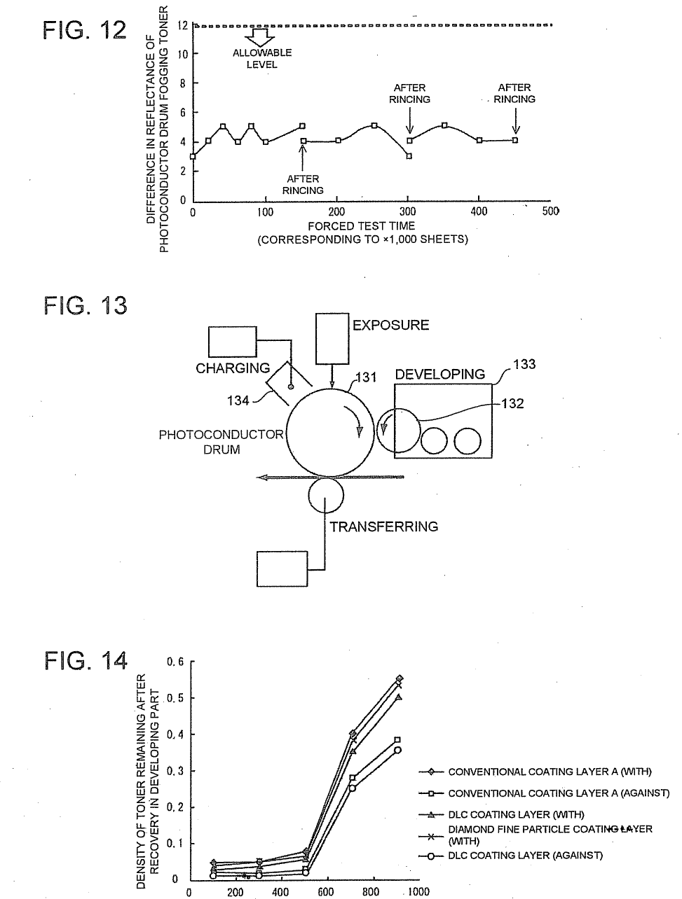

FIG. 12 shows the dependency of the attached amount of the carrier particles associated with rinsing on the forced test time (number of sheets printed). The attached amount of the carrier particles is substantially not changed from the initial stage irrespective of rinsing. It is understood that even when the carrier particles are rinsed, the coating layer is not peeled off, but only the attached matters are removed.

It is understood from the results that upon rinsing the carrier particles, the fogging amount is restored to the initial level, and the attached amount of the carrier particles is not changed, whereby the carrier particles can be reused semipermanently by rinsing.

### [Evaluation in Cleanerless Process]

### (Evaluation of Recovering Performance)

FIG. 13 is a schematic diagram showing an electrophotographic printer of a cleanerless process. The electrophotographic printer shown in FIG. 13 is different from that shown in FIG. 6 in the point that the cleaner for a photoconductor 131 is not provided. The toner particles remaining after transferring are recovered by a developing device 133 having a developing roller 132. For recovering the toner particles remaining after transferring by the developing device 133, the toner particles remaining after transferring are charged with a corona discharging device 134, and then a strong electric field is applied to the developing part, whereby the toner particles are mechanically scraped with the developer in contact with the photoconductor drum 131.

The toner recovery performance particles to the developing device upon changing the gap between the developing roller and the photoconductor drum is evaluated by using the electrophotographic printer. In this evaluation, developers containing toner particles containing a pulverized toner containing a styrene-acrylic resin as a major component having 0.5% by weight of a CCA added thereto, and the carrier particles of the samples 2 and 6 and the comparative example 1, respectively, are used.

In the transferring part, a halftone image having an area ratio of 50% is left on the photoconductor with an area of about 1 cm² in the absence of a bias applied. The image left on the photoconductor is not cleaned but is negatively charged with the corona charging device 134. The developer is recovered to the developing device 133 with a voltage of −500 V applied to the photoconductor drum and a developing bias of −150 V, and then the toner particles remaining on the photoconductor drum 131 are collected with a plastic adhesive tape (Mending Tape).

The toner particles thus collected are adhered to white paper, and the reflection density thereof is measured with a Macbeth reflection densitometer. The plastic adhesive tape itself is similarly adhered to white paper and measured for reflectance density. The difference in reflection density is designated as the density of the toner remaining after transferring. Under the condition where the developer is not recovered in the developing device 133, the density of the toner remaining after transferring is 0.7, and when the developer is entirely recovered, the density of the toner remaining after transferring is 0. The ratio of peripheral speeds between the developing roller 132 and the photoconductor drum 131 is 2/1 when the rotation directions thereof are the same as each other (with directions), and is 1/1 when they are against each other (against directions).

FIG. 14 shows the dependency of the density of the toner remaining after recovery on the gap between the developing roller and the photoconductor. The density of the toner remaining after recovery obtained in the case where the rotation directions of the developing roller and the photoconductor drum are with directions is lower than that obtained in the case where they are against directions, and thus it is understood that high recovery performance of the developing device is obtained. In both cases, the recovery performance is steeply decreased when the gap exceeds about 500 μm.

It is also understood that the carrier particles using a DLC film (sample 2) and the carrier particles using diamond fine particles (sample 6) have a tendency of exhibiting slightly high recovery performance as compared to the carrier particles having a conventional coating layer containing only a resin (comparative example 1).

### [Evaluation of Surface Roughness of Photoconductor Drum on Continuous Durability Test]

The surface roughness of the photoconductor drum when the gap between is evaluated upon changing the gap between the developing roller and the photoconductor drum is evaluated by using the electrophotographic printer. The same developers as in the evaluation of the recovery performance are used, and the photoreceptor drum subjected to the same continuous printing test as in the evaluation of the fogging amount is measured for surface roughness after printing 10,000 sheets. The surface roughness herein is a ten-point surface roughness (Rz) measured with a contact type surface roughness meter (Serfcorder).

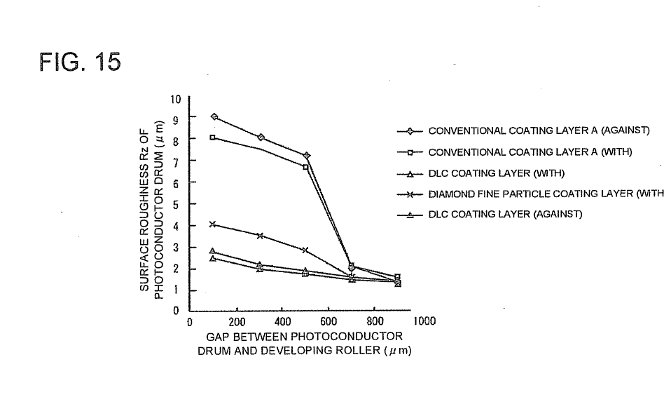

FIG. 15 shows the dependency of the surface roughness of the photoconductor on the gap between the developing roller and the photoconductor. With the carrier particles having a conventional coating layer containing only a resin (comparative example 1), the surface roughness of the photoconductor drum is steeply increased when the gap is 500 μm or less. On the other hand, the surface roughness is not largely changed with the carrier particles using a DLC film (sample 2) and the carrier particles using diamond fine particles (sample 6).

It is understood as follows taking the aforementioned results in consideration. In the cleanerless process, a carrier chain formation (a magnetic brush) is formed with a carrier in the developing part, and the height of the chain partially becomes about 500 μm, which is formed with 13 carrier particles connected each having a diameter of 40 μm. When the gap between the developing roller and the photoconductor drum is 500 μm or less, the tip of the magnetic brush is in contact with the photoconductor drum. When the gap is less than 500 μm, the recovery performance of the toner is enhanced by the mechanical scraping effect, but the surface of the photoconductor drum is roughened by the tip of the magnetic brush in contact with the photoconductor drum.

Accordingly, the use of the carrier particles excellent in lubricating property owing to a DLC film or diamond fine particles contained reduces the stress applied to the photoconductor drum even when the developer is made in contact with the photoconductor drum for recovering the toner on the photoconductor drum in the developing part. In other words, in the cleaner less process using no cleaning blade, the recovery performance can be enhanced, and the surface of the photoconductor drum can be prevented from being roughened. Consequently, the service life of the photoconductor drum can be enhanced.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. Carrier particles for a developer, the carrier particles comprising
a core material containing magnetic particles, and
a coating layer formed on a surface of the core material,
the coating layer comprising diamond fine particles or diamond-like carbon exposed on a surface of the coating layer.

2. The carrier particles according to claim 1, wherein the coating layer has a thickness of from 0.3 to 5 μm.

3. The carrier particles according to claim 2, wherein the coating layer has a thickness of from 0.5 to 3 μm.

4. The carrier particles according to claim 1, wherein the coating layer contains a layer containing a resin having diamond fine particles dispersed in the resin.

5. The carrier particles according to claim 4, wherein the resin contains one of an acrylic resin, a fluorine resin, a silicone resin, a melamine resin, a urethane resin and a urethane elastomer.

6. The carrier particles according to claim 4, wherein a content of the diamond fine particles in the resin is from 0.1 to 20% by weight.

7. The carrier particles according to claim 4, wherein the carrier particles is produced by coating a dispersion liquid containing the resin and the diamond fine particles dispersed in the dispersion liquid, on the core material.

8. The carrier particles according to claim 1, wherein the coating layer contains a layer of diamond-like carbon.

9. The carrier particles according to claim 8, wherein the layer of diamond-like carbon is formed by a CVD method.

10. The carrier particles according to claim 1, wherein the carrier particles are negatively charging carrier particles.

11. The carrier particles according to claim 1, wherein the carrier particles are rinsed for reusing.

12. A developer comprising:
carrier particles comprising a core material containing magnetic particles, and a coating layer formed on a surface of the core material; and
toner particles,
wherein the coating layer comprising diamond fine particles or diamond-like carbon exposed on a surface of the coating layer.

13. An image forming apparatus forming an image with toner particles on a transfer medium, the apparatus comprising:
an image holding member having an electrostatic latent image formed on the image holding member, and
a developing device to charge toner particles and carrier particles by agitation, and the developing device to develop the electrostatic latent image on the image holding member by attaching the toner particles to the electrostatic latent image,
wherein the carrier particles comprise a core material containing magnetic particles, and a coating layer formed on a surface of the core material, the coating layer comprising diamond fine particles or diamond-like carbon exposed on a surface of the coating layer.

14. The apparatus according to claim 13, wherein the coating layer has a thickness of from 0.3 to 5 μm.

15. The apparatus according to claim 14, wherein the coating layer has a thickness of from 0.5 to 3 μm.

16. The apparatus according to claim 13, wherein the coating layer contains a layer containing a resin having diamond fine particles dispersed in the resin.

17. The apparatus according to claim 13, wherein the coating layer contains a layer of diamond-like carbon.

18. The apparatus according to claim 17, wherein the carrier particles are rinsed after being used for developing.

19. The apparatus according to claim 13, wherein the toner particles remaining on the image holding member are recovered to the developing device with the carrier particles upon developing.

20. The apparatus according to claim 19, wherein the developing device comprises a developing roller facing the image holding member, and
a gap between the developing roller and the image holding member is 500 μm or less.
